(19) United States
(12) Patent Application Publication
(10) Pub. No.: US 2006/0038015 A1
(43) Pub. Date: Feb. 23, 2006

(54) Effectiveness evaluation method for web content, web content retrieval method and web content accounting method using the same, and retrieval server and content providing device

(75) Inventors: Hideki Ise, Kawasaki (JP); Mayumi Tokunaga, Kawasaki (JP); Hidenori Matsushita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/256,957

(22) Filed: Oct. 25, 2005

Related U.S. Application Data
(63) Continuation of application No. PCT/JP03/05416, filed on Apr. 28, 2003.

(51) Int. Cl. G06K 7/10

(52) U.S. Cl. 235/462.1

(57) ABSTRACT

A evaluation method evaluates the effectiveness of the content of a Web site connected with a client via a network. The method has a step of accessing the Web site and displaying a content of the Web site, a step of measuring the status of viewing one content by the client and sending the result to the Web site, and a step of calculating the utilization rate of the one content from the measurement result. Since the actual status of viewing one Web content by a client is measured and the utilization rate is calculated, the effectiveness of the Web content can be accurately evaluated. Also the retrieval result can be provided and accounting can be performed according to the effectiveness.

### CROSS-REFERENCE TO RELATED APPLICATIONS

This application is a continuation of international application PCT/JP2003/005416, filed on Apr. 28, 2003.

### TECHNICAL FIELD

The present invention relates to an effectiveness evaluation method for evaluating the effectiveness of the Web content distributed over the Internet and intranets, a Web content retrieval method for retrieving Web content using the evaluation, and a Web content accounting method for accounting using the evaluation, and a retrieval server and a content providing device thereof.

### RELATED ART

Along with the recent advancements in communication technology, in a communication environment, various Web content constructed by Web site constructors can be accessed via the Internet and intranets. The content of such Web sites is so numerous and difficult to retrieve, so they can be browsed only in a limited range. For this a retrieval site and a knowledge site are accessed.

For these Web sites and retrieval sites, the access status of Web content is an important component. For example, in the case of a chargeable site, a charge is collected from the site user according to the access status. Also in the case of a retrieval site, a site evaluated as having good retrieval efficiency and which is rated as higher access is one which ranks the Web content according to the access status, and provides it when a user retrieves the Web content by keyword.

As a method for evaluating such access status of Web content, a method of which the evaluation standard is the number of times when the content is viewed, that is the access count, has been known (e.g. Japanese Patent Application Laid-Open No. 2002-216008 and Japanese patent Application Laid-Open No. H10-240829).

With this method of which the evaluation target is the access count however, it cannot be evaluated whether the user received effective information. In other words, even if a content is accessed, this content may not be meaningful for the user. Even if retrieving such content as content with high priority, it decreases the evaluation of the search engine of the retrieval site, and leads to a drop in the utilization rate of the retrieval site.

Also in the case of a chargeable site which is charged by the access count, the user must pay even if effective information is not received, so the access count of the chargeable content drops, and the sales of the content provider does not increase.

### DISCLOSURE OF THE INVENTION

With the foregoing in view, it is an object of the present invention to provide an effectiveness evaluation method for evaluating the effectiveness of the Web content by tabulating how many amount a user has viewed the content itself of a Web site.

It is another object of the present invention to provide a Web content retrieval method, a Web content accounting method, a retrieval server and a content providing device for retrieving or accounting the Web content using this evaluation.

It is still another object of the present invention to provide an effectiveness evaluation method for Web content for evaluating the effectiveness of the content of a Web site by detecting how many amount a user has viewed the content itself.

It is still another object of the present invention to provide a Web content retrieval method, a Web content accounting method, a retrieval server and a content providing device for retrieving or accounting the Web content using this evaluation.

To achieve these objects, the present invention provides a method for evaluating the effectiveness of the content of a Web site connected with a client via a network, has a step of the client accessing the Web site and displaying a content of the Web site, a step of measuring the status of viewing one content by the client and sending the result to the Web site, and a step of calculating the utilization rate of the one content from the measurement result.

The retrieval method and the retrieval server of the present invention transmit the retrieval result referring to the utilization rate. The accounting method and the content providing device of the present invention calculate an amount to be billed from the utilization rate and the general charge.

In the present invention, the actual status of the viewing one content is measured and the utilization rate is calculated, so the effectiveness of the content can be accurately evaluated. And the retrieval result and accounting according to the effectiveness can be provided.

In the present invention, it is preferable that the calculation step further has a step of calculating the utilization rate from a size of a browser of the client, a size of the content and a click count by the client. By this, the status of viewing one content can be measured while transparent to the user, which can be implemented easily and simply.

In the present invention, it is preferable that the calculation step further has a step of calculating the utilization rate from a moving amount of a scroll bar of the browser of the client, and a size of the browser. By this, the status of viewing one content can be measured while transparent to the user, which can be implemented easily and simply.

Also in the present invention, it is preferable that the calculation step further has a step of calculating the utilization rate from the total number of pages of the content and the number of pages viewed by the client. By this, the status of viewing one content can be measured while transparent to the user, which can be implemented easily and simply.

### BRIEF DESCRIPTION OF THE DRAWINGS

FIG. 1 is a diagram depicting the configuration of the system according to an embodiment of the present invention;

FIG. 2 is a flow chart depicting the processing of the Web browser in FIG. 1;

FIG. 3 is a flow chart depicting the content transmission processing by the Web server in FIG. 1;

FIG. 4 is a flow chart depicting the effectiveness calculation processing by the Web server in FIG. 1;

FIG. 5 is a table describing the effectiveness evaluation example in FIG. 1;

FIG. 6 is a diagram depicting the configuration of the system according to another embodiment of the present invention;

FIG. 7 is a diagram depicting an applet program which operates like a browser in FIG. 6;

FIG. 8 is a diagram depicting the utilization rate calculation by the scroll bar in FIG. 7;

FIG. 9 is a diagram depicting the initial value calculation of the utilization rate in FIG. 8;

FIG. 10 is a diagram depicting the utilization rate calculation when the scroll bar is operated in FIG. 8;

FIG. 11 is a diagram depicting the configuration of the system according to still another embodiment of the present invention;

FIG. 12 is a diagram depicting the configuration of the content in FIG. 11;

FIG. 13 is a diagram depicting the configuration of the files of the server in FIG. 11;

FIG. 14 is a flow chart depicting the content transmission processing by the Web server in FIG. 11;

FIG. 15 is a flow chart depicting the effectiveness calculation processing by the Web server in FIG. 11;

FIG. 16 is a table describing the effectiveness evaluation example in FIG. 15;

FIG. 17 is a diagram depicting the configuration of the retrieval system according to an embodiment of the present invention;

FIG. 18 is a diagram depicting the retrieval screen in FIG. 17;

FIG. 19 is a diagram depicting the screen of the knowledge system in FIG. 17;

FIG. 20 is a block diagram depicting the accounting system according to an embodiment of the present invention; and

FIG. 21 is a table describing the accounting processing in FIG. 20;

### DESCRIPTION OF THE PREFERRED EMBODIMENTS

Embodiments of the present invention will now be described in the sequence of first embodiment, second embodiment, third embodiment, retrieval system, accounting system and other embodiments, of the evaluation method for Web content.

### First Embodiment of Web Content Evaluation Method

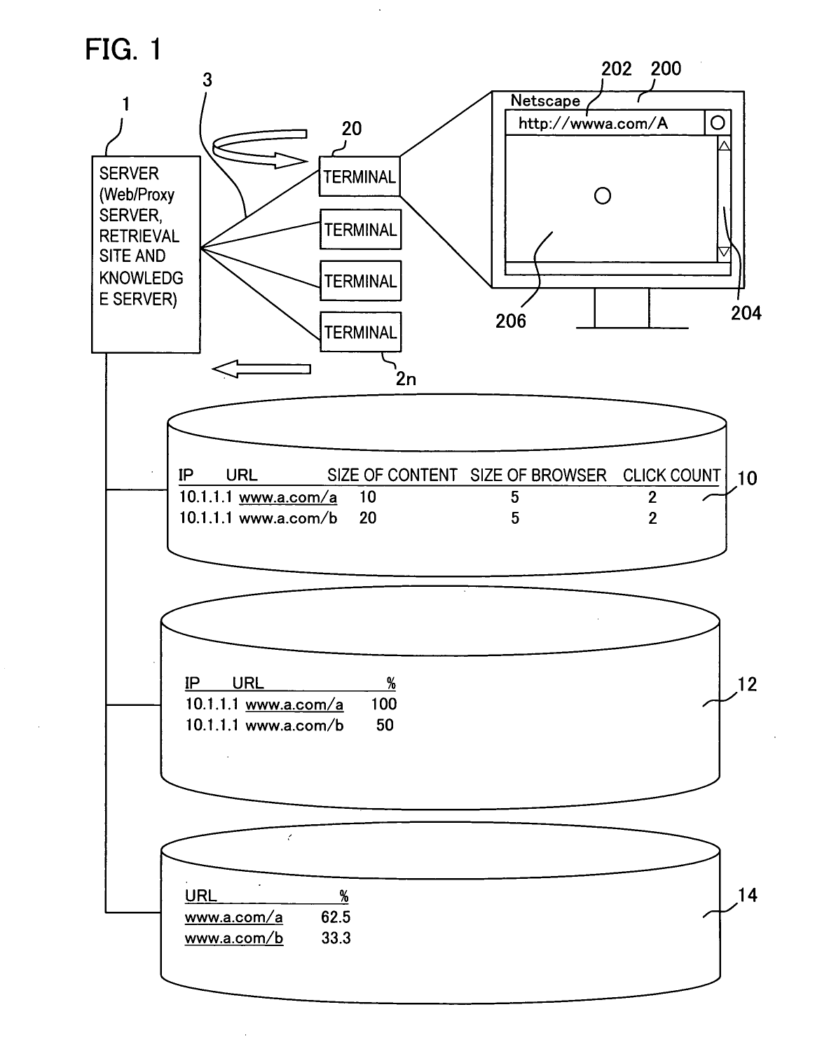

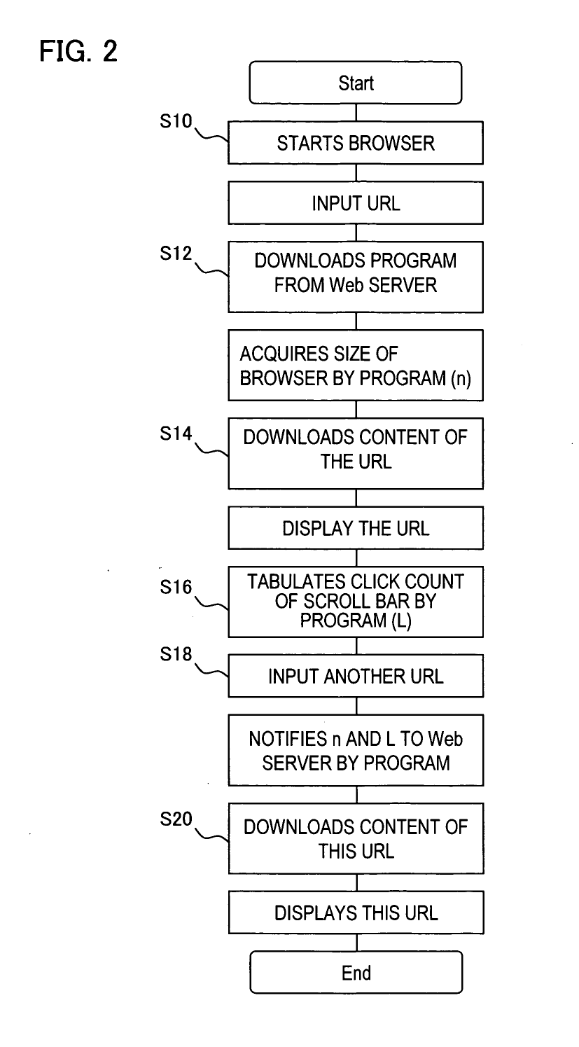

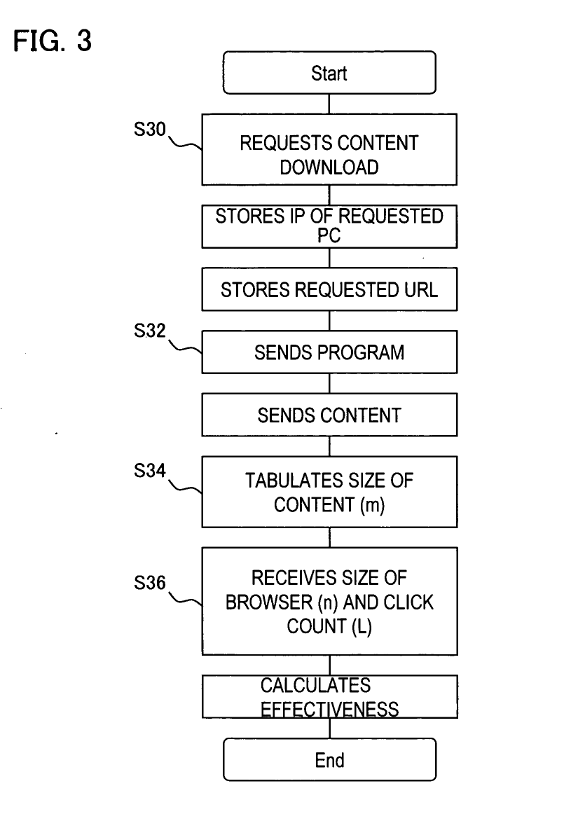

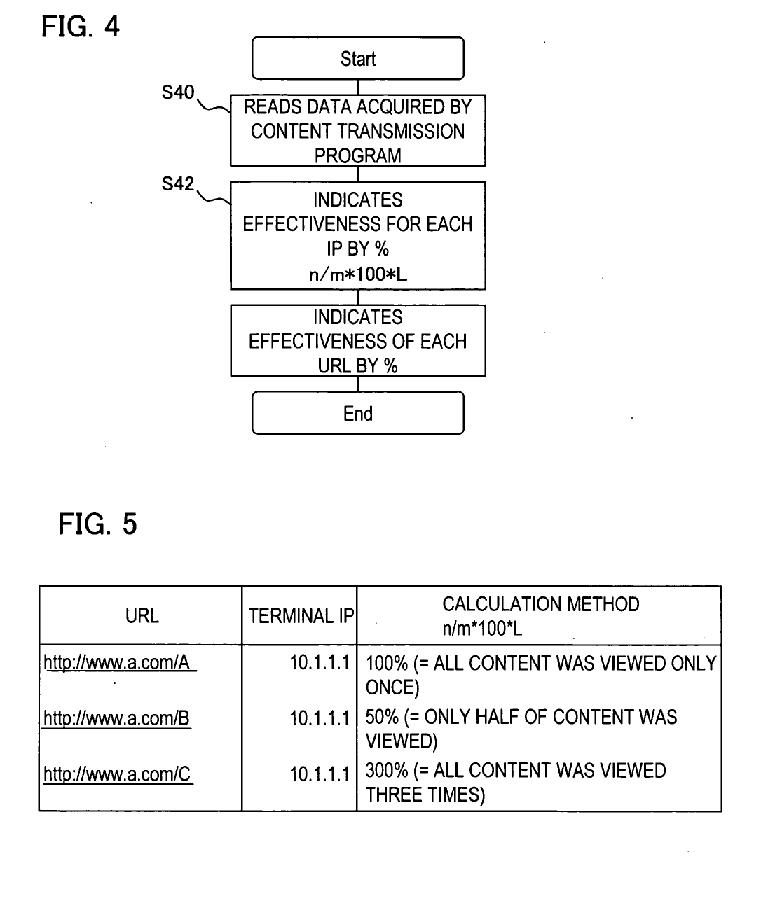

FIG. 1 is a diagram depicting the system configuration according to the first embodiment of the present invention, FIG. 2 is a flow chart depicting the processing of the Web browser of the terminal in FIG. 1, FIG. 3 is a flow chart depicting the content transmission processing by the Web server in FIG. 1, FIG. 4 is a flow chart depicting the content effectiveness calculation by the Web server in FIG. 3, and FIG. 5 is a table describing a content effectiveness evaluation.

As FIG. 1 shows, the Web server (Web server/proxy server, retrieval server, knowledge server, etc.) 1 is connected to a plurality of terminals 20 to 2n via the Internet or the intranet 3. The terminals 20 to 2n access the Web server 1 or the content site retrieved thereby using the browser, and displays the content.

Each of the terminals 20 to 2n has a display device 200, on which the browser window is displayed when the browser is started up. This window is comprised of the URL (Uniform Resource Locator) bar 202 of the site, scroll bar 204 and browser window 206. The size (n lines) of the browser window 206 is defined by the browser.

The Web server 1 is comprised of an access data file 10 for storing the access data (size of content, size of browser, click count) of each access terminal, a terminal file 12 for storing the effectiveness of the content of each access terminal, and a URL file 14 for storing the effectiveness of each URL.

The processing by the Web browser on the terminal will be described with reference to FIG. 2.

(S10) The browser is started up on the terminal 20, and the URL is input to the URL bar 202, and is sent to the Web server 1.

(S12) The program (content transmission program) is downloaded from the Web server 1 to the terminal 20. By this program, the size (n lines) of the browser (window) 206 of the terminal 20 is acquired.

(S14) Then the content of this URL is downloaded to the terminal 20. The terminal 20 displays the content of this URL on the display device 200.

(S16) The user views a part of the content displayed on the browser window 206 of the display device 200, clicks on the scroll bar 204 if interested, and displays the other portion of the content on the window by manipulating page-up or page-down. The downloaded program tabulates the click count L of the scroll bar manipulated by page-up/page-down.

(S18) When the user ends viewing this content, and inputs another URL to the terminal 20 to view other content, or when the user exits the browser, the downloaded program notifies the detected size n of the browser window and the click count L to the Web server 1.

(S20) If another URL is input, the content of this URL is downloaded to the terminal 20. The terminal 20 displays the content of this URL on the display device 200. And [processing] hereafter is as described above.

In this way the access status of the content can be detected by the size of the browser and the click count of page-up/page-down, out of the downloaded content.

The Web server 1 stores the IP address of the terminal, URL, size m of the content, and the notified size n of the browser and the click count L in the access data file 10.

Now the processing of the Web server 1 will be described with reference to FIG. 3 and FIG. 4.

(S30) When the download request for content is received from the terminal 20, the Web server 1 stores the IP address of the terminal (PC) which sent the request to the file 10, and then stores the requested URL in the file 10.

(S32) Then the Web server 1 sends the above mentioned content transmission program to the terminal 20, and sends the content of the URL to the terminal 20.

(S34) The Web server 1 tabulates the size m (e.g. number of lines) of the transmitted content.

(S36) The Web server 1 receives the above mentioned size n of the browser and the click count L from the terminal 20, and stores them in the file 10.

(S38) Then the Web server 1 calculates the effectiveness as shown in FIG. 4.

The calculation processing for effectiveness will be described with reference to FIG. 4.

(S40) The data acquired from the file 10 by the content transmission program is read.

(S42) The effectiveness is calculated using the following expression for each terminal IP, and is stored in the terminal file 12.
Effectiveness=n/m*100*L

(S44) In the same way, the effectiveness is calculated for each URL using the following expression and is stored in the URL file 14.
Effectiveness=n/m*100*L

FIG. 5 is a table describing the effectiveness for each URL. If the effectiveness is 100%, this means that all the content was viewed once, if the effectiveness is 50%, this means that only half of the content was viewed, and if the effectiveness is 300%, this means that all the content was viewed three times.

Since the actual status of viewing the content is measured in this way, the effectiveness of the content can be accurately evaluated. In this example, the size of the browser and the click count are measured, so the actual status of viewing the content can be easily measured.

### Second Embodiment of Web Content Evaluation Method

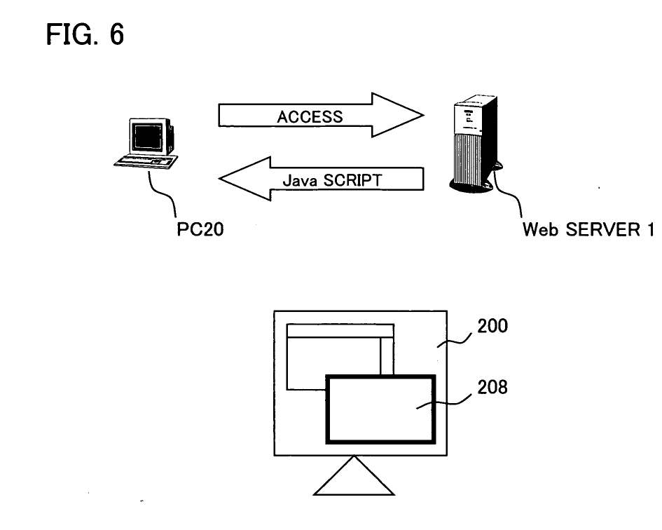

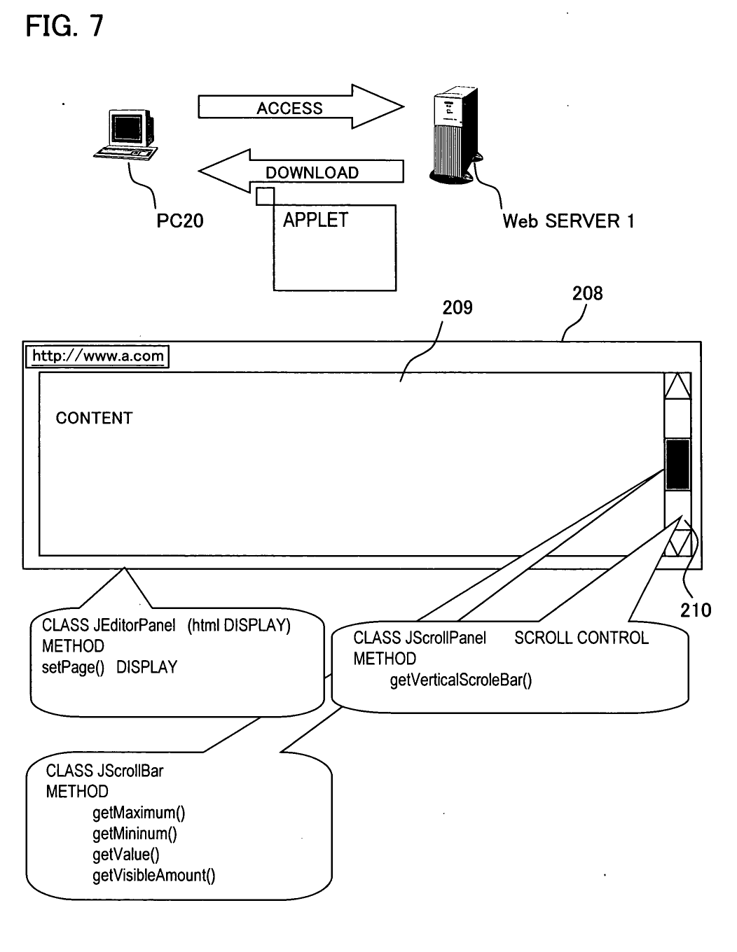

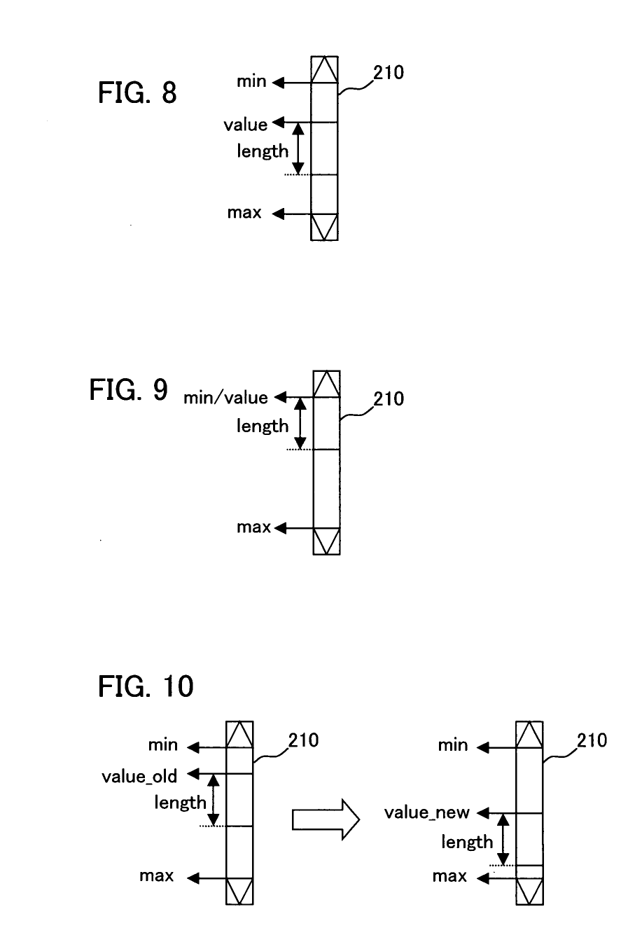

FIG. 6 is a diagram depicting the configuration of the second embodiment of the present invention, FIG. 7 is a diagram depicting the applet program which operates like a browser in the configuration of FIG. 6, and FIG. 8 to FIG. 10 are diagrams depicting the content effectiveness calculation processing.

As FIG. 6 shows, the Web server 1 having the content is accessed from the browser of the terminal (PC) 20. Responding to this, the Web server 1 sends a JavaScript to the terminal 20, and displays a separate window. In other words, a separate window is opened on the display device 200 of the terminal 20 using “window.Open( )” of JavaScript, and the window 208, without the scroll bar and tool bar, is displayed.

Then as FIG. 7 shows, the applet program is downloaded from the Web server 1, and is displayed on the window 208. As FIG. 7 shows, the screen 208 becomes a screen like a browser, where the content 209 and the scroll bar 210 are displayed. This applet program is defined by class and method, and the html display screen is defined by the JEditor Panel, the scroll control is defined by the JScroll Panel, and the scroll bar is defined by the JScroll Bar.

As FIG. 8 shows, the last line (at the very bottom end of the scroll bar) max of the content is acquired by the getMaximum method of the JScroll Bar, the start line (the very top end of the scroll bar) min of the content by the getMinimum method, the current position (value) of the scroll bar is by the getvalue method, and the size of the browser (the length of the scroll bar) length of the browser by the getVisibleAmount method.

The initial value of the utilization rate (effect) is calculated by length/(max−min)*100, as shown in FIG. 9. When the scroll bar is operated the next time, the increment of the utilization rate (effect) is calculated by (value_new−value_old)/(max−min)*100. By accumulating the increment of the utilization rate (effect), the utilization rate (effect) is calculated.

In this way, one content 208 is scrolled in the browser screen by the operation of the scroll bar, and the utilization rate (effect), according to the operation amount of the bar, is calculated.

And the terminal 20 acquires this utilization rate either by clicking on the link in the content or by the timing when the browser closes, and transmits this to the Web server 1 by http. The Web server 1 logs the site name and the utilization rate (effect) as a set in the log files 12 and 14 by a cgi program, just like FIG. 1.

The retrieval site uses this utilization rate for the retrieval service as the scale of the effectiveness. The retrieval site also acquires the information of a separate server as the utilization rate according to the above mentioned procedure by caching the data of the separate server.

Since the actual status of viewing the content is measured by the operation of the scroll bar in this way, the effectiveness of the content can be accurately evaluated. Also in this example, the size of the browser and the operation amount of the scroll bar are measured, so the actual status of viewing the content can be easily measured.

### Third Embodiment of Web Content Evaluation Method

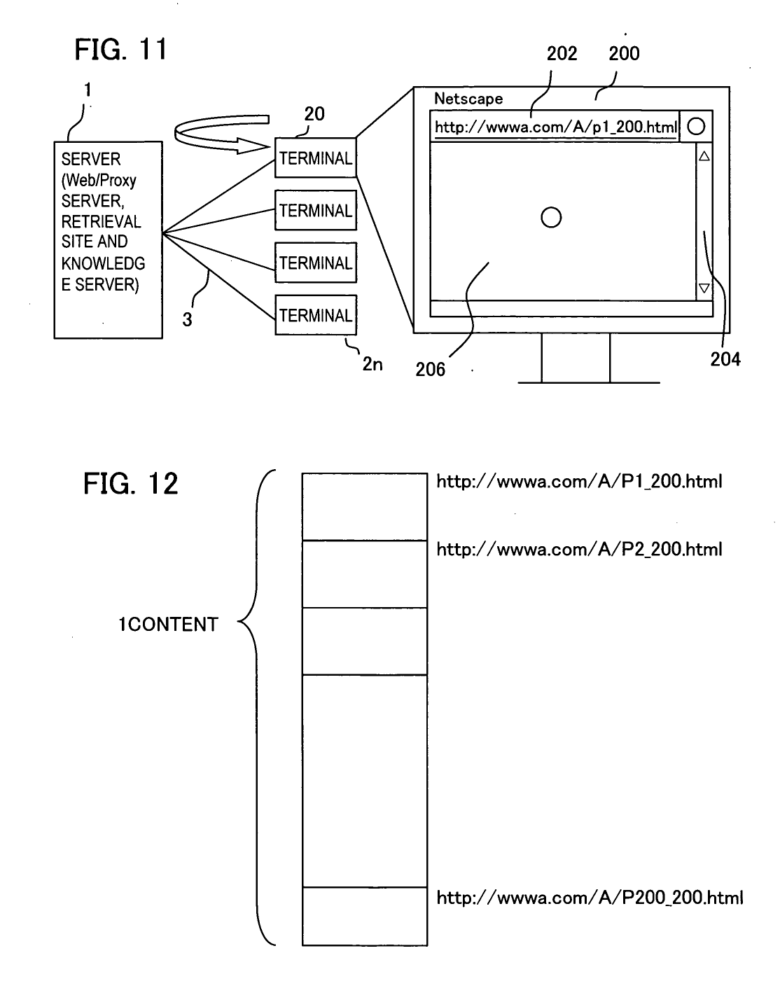

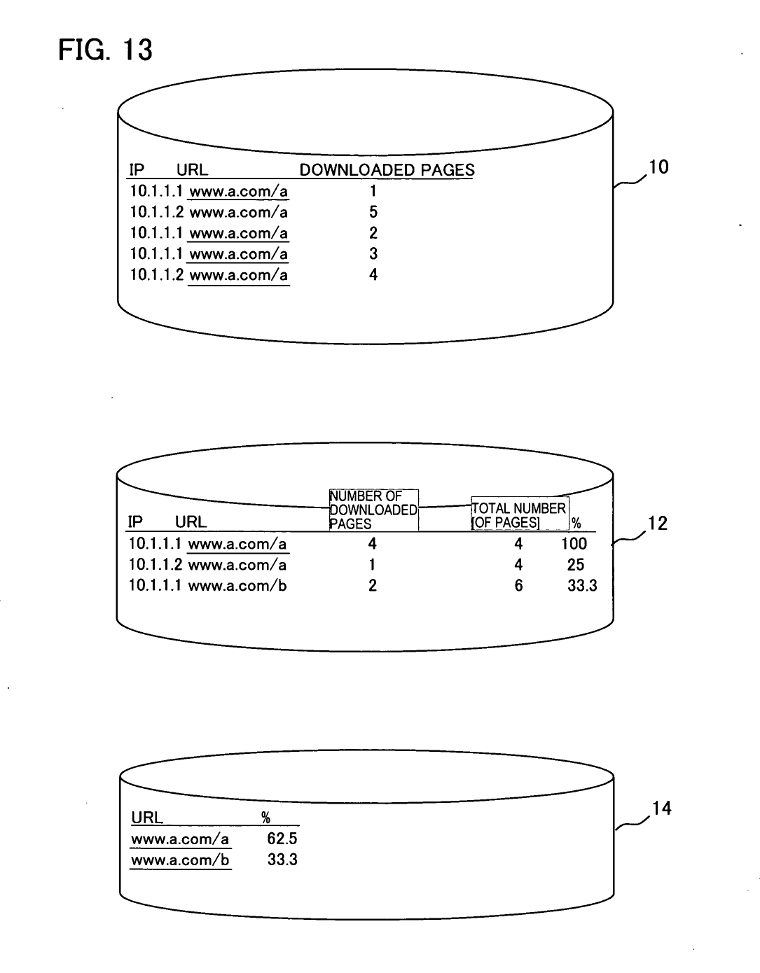

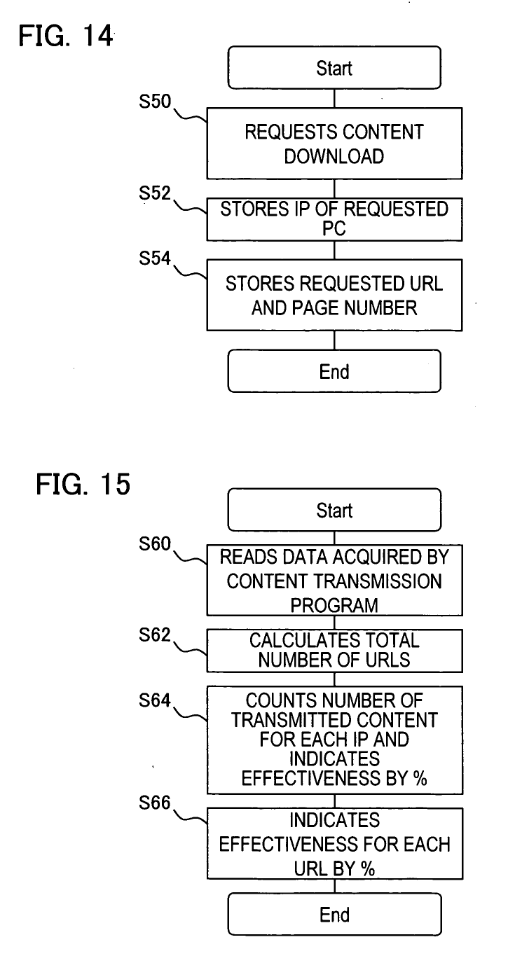

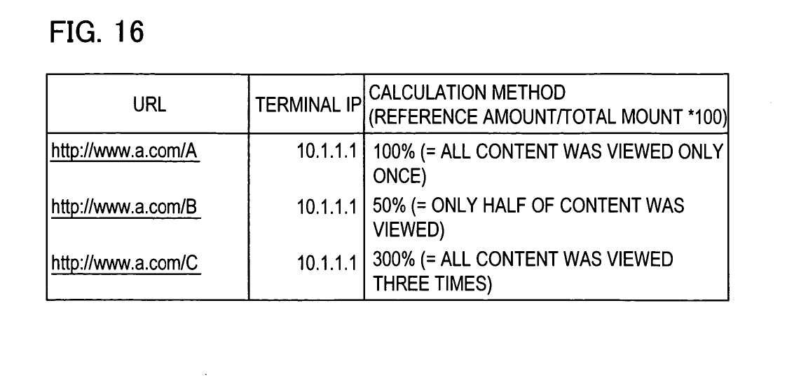

FIG. 11 is a diagram depicting the system configuration according to the third embodiment of the present invention, FIG. 12 is a diagram depicting the configuration of the Web content in FIG. 11, FIG. 13 are diagrams depicting the configuration of files of the Web server in FIG. 11, FIG. 14 is a flow chart depicting the content transmission processing by the Web server in FIG. 11, FIG. 15 is a flow chart depicting the content effectiveness calculation by the Web server in FIG. 11, and FIG. 16 is a table describing the content effectiveness evaluation.

As FIG. 11 shows, the Web server (Web server/proxy server, retrieval-server, knowledge server, etc.) 1 is connected to a plurality of terminals 20 to 2n via the Internet or intranet 3. The terminals 20 to 2n access the Web server 1 or the content site retrieved thereby using the browser, and displays the content.

Each of the terminals 20 to 2n has a display device 200, on which a browser window is displayed when the browser is started up. This window is comprised of the URL (Uniform Resource Locator) bar 202 of this site, scroll bar 204 and browser window 206. The size (n lines) of the browser window 206 is defined by the browser.

As FIG. 12 shows, one content is divided into a plurality of sections, and the total amount and the current location are defined by the URL. For example, the current location is defined by page 1, 2, 3, . . . of the Page 200.

As FIG. 13 shows, the Web server 1 is comprised of an access data file 10 for storing the access data (URL, downloaded page) of each access terminal IP, a terminal file 12 for storing the effectiveness of the content of each access terminal, and a URL file 14 for storing the effectiveness of each URL.

The processing by the Web server 1 will be described with reference to FIG. 14 and FIG. 15.

(S50) The Web server 1 receives the content download request from the terminal 20.

(S52) First the IP address of the requesting terminal (PC) is stored in the file 10.

(S54) The page of the requested URL is sent to the terminal, and the requested URL and the page number are stored in the file 10.

The calculation processing for effectiveness will be described with reference to FIG. 15.

(S60) The data acquired from the file 10 by the content transmission program is read.

(S62) The total number of requested URLs (total number of pages) is calculated.

(S64) The number of transmitted contents (number of pages) is counted for each terminal IP, and the effectiveness is calculated by the following expression and is stored in the terminal file 12.
Effectiveness=number of transmitted contents/total number of URLs

(S66) in the same way, the effectiveness is calculated for each URL using the following expression and is stored in the URL file 14.
Effectiveness=number of transmitted content/total number of URLs

FIG. 16 is a table describing the effectiveness for each URL. If the effectiveness is 100%, this means that all the content was viewed once, if the effectiveness is 50%, this means that only half of the content was viewed, and if the effectiveness is 300%, this means that all the content was viewed three times.

Since the actual status of viewing the content is measured by dividing one content and counting the number of requests in this way, the effectiveness of the content can be accurately evaluated. In this example, the number of requests of the content is measured, so the actual status of viewing the content can be easily measured.

Retrieval System

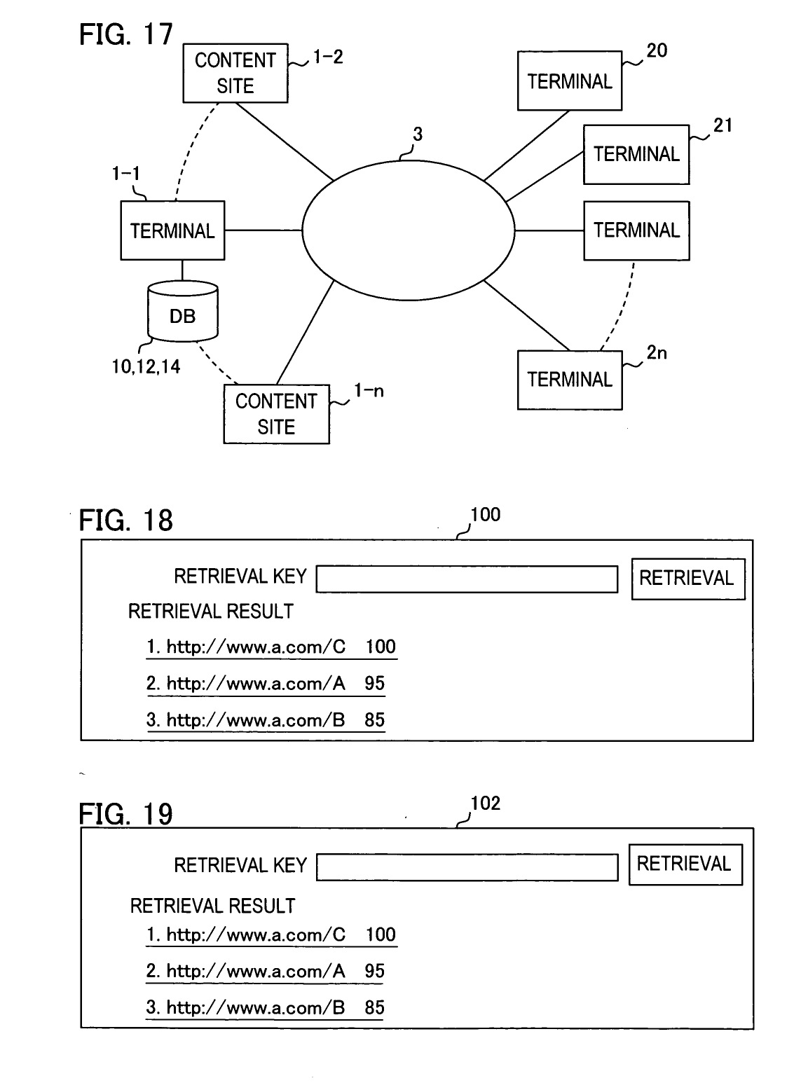

The retrieval system using the above mentioned content evaluation method will be described. FIG. 17 is a block diagram depicting the entire retrieval system according to an embodiment of the present invention, FIG. 18 is a diagram depicting the retrieval result of the retrieval site in FIG. 17, and FIG. 19 is a diagram depicting the retrieval result when the retrieval site in FIG. 17 is a knowledge site.

As FIG. 17 shows, the retrieval server (or knowledge server) 1-1 is connected to a plurality of terminals 20 to 2n and a plurality of content sites (servers) 1-2, . . . 1-n, via the Internet 3. The plurality of terminals 20 to 2n access the retrieval server 1-1 by the browser, and the retrieval server 1-1 retrieves the content sites 1-2 to 1-n according to the retrieval key.

The retrieval site 1-1 comprises an access data file 10, terminal file 12 and URL file 14 described in FIG. 1 to FIG. 13, and as the retrieval screen in FIG. 18 shows, displays the URL site retrieved by the retrieval key which was input from the terminal, along with the utilization rate, in the sequence of the utilization rate of the URL stored in the URL file 14.

Each of the terminals 20 to 2n has a display device as mentioned above, where the browser window is displayed by starting up the browser. The retrieval site is accessed, the retrieval key is input in the retrieval screen in FIG. 18, and retrieval is specified.

By this, the retrieval site 1-1 retrieves the content site corresponding to the retrieval key, and displays the URL (Uniform Resource Locator) of the retrieved content on the retrieval screen of the terminal, along with the utilization rate, in the sequence of the utilization rate of the URL stored in the URL file 14. The terminals 20 to 2n are used to click the URL displayed on the retrieval screen 100, and the target content is acquired.

The retrieval site 1-1 collects the access data of each access terminal, stores it in the access data file 10, and updates the terminal file 12 for storing the effectiveness of the content of each access terminal and the URL file 14 for storing the effectiveness of each URL according to the utilization rate.

This retrieval site 1-1 may be a knowledge system as shown in FIG. 19, which displays the similar retrieval screen 102 and retrieves the content in the same way.

Since the actual status of viewing the content is measured in this way, and the priority of the retrieval result is determined using the evaluation method which can accurately evaluate the effectiveness of the content, the retrieval hit rate improves, and the access of the retrieval site can be promoted.

Accounting System

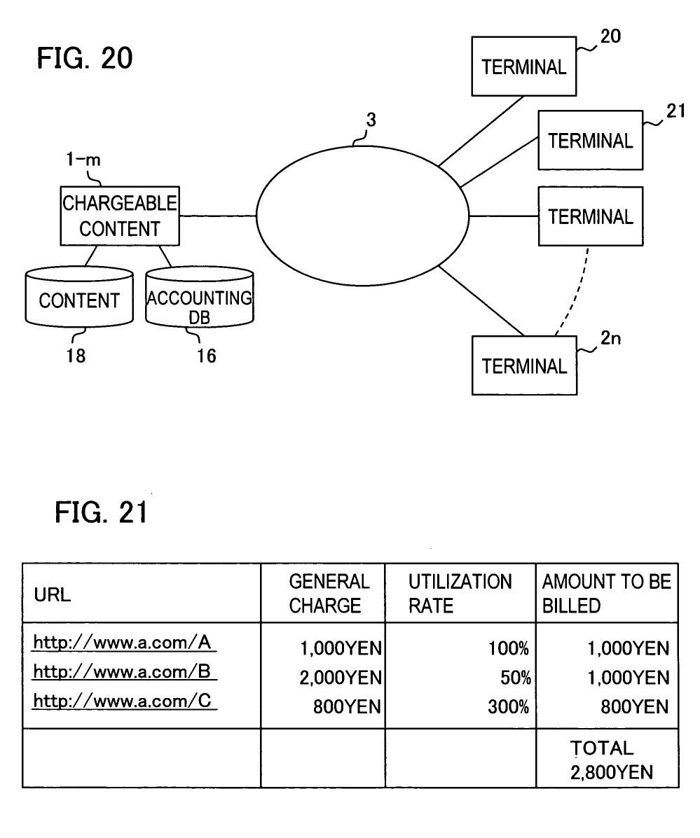

The accounting system using the above mentioned content evaluation method will be described next. FIG. 20 is a block diagram depicting the entire accounting system according to an embodiment of the present invention, and FIG. 21 is a table describing the accounting result in FIG. 18.

As FIG. 20 shows, the chargeable content server 1-m is connected to a plurality of terminals 20 to 2n via the Internet 3. The plurality of terminals 20 to 2n access the chargeable content server 1-m by the browser. The chargeable content server 1-m comprises the content data base 18 and the accounting data base 16. The accounting data base 16 includes the above mentioned access data file 10, terminal file 12 and URL file 14.

Each of the terminals 20 to 2n has the display device 200 as mentioned above, displays the browser window by starting up the browser, and accesses the chargeable content site 1-m.

The chargeable content site 1-m calculates the utilization rate of the terminal as mentioned above, and as FIG. 21 shows, calculates the amount to be billed at every predetermined period (e.g. one month) by multiplying the general charge of each URL by the utilization rate, creates the general charge, the utilization rate, the amount to be billed, and the total amount for each terminal IP, and registers this in the accounting data base 16. By this, a bill is created and charged to the user.

Since the actual status of viewing the content is measured and accounting is performed using the evaluation method which can accurately evaluate the effectiveness of the content, accounting whereby both the user and the site administrator can satisfy can be performed.

### Other Embodiments

The present invention was described using the embodiments, but the present invention can be modified in various ways within the scope of the essential character of the present invention, and these shall not be excluded from the technical scope of the present invention. For example, the present invention was described as in Internet connection, but can also be applied to an intranet connection.

### INDUSTRIAL APPLICABILITY

In the present invention, the actual status of client viewing one Web content is measured and the utilization rate is calculated, so the effectiveness of the Web content can be accurately evaluated. Also the retrieval result and the accounting according to the effectiveness can be provided.

1. A method for evaluating the effectiveness of content of a Web site connected with a client via a network, comprising the steps of:
accessing said Web site and displaying a content of said Web site with said client;
measuring a status of viewing one content by said client and sending the result to said Web site; and
calculating the utilization rate of said one content from said measurement result.

2. The effectiveness evaluation method for Web content according to claim 1,
wherein said calculation step comprises a step of calculating said utilization rate from a size of a browser of said client, a size of said content and a click count by said client.

3. The effectiveness evaluation method for Web content according to claim 1,
wherein said calculation step further comprises a step of calculating said utilization rate from a moving amount of a scroll bar in a browser of said client, and a size of said browser.

4. The effectiveness evaluation method for Web content according to claim 1,
wherein said calculation step further comprises a step of calculating said utilization rate from a total number of pages of said content, and the number of pages viewed by said client.

5. A method for retrieving a content requested in a retrieval site connected with a client via a network, comprising the steps of:
accessing said retrieval site with said client;
measuring a status of viewing one content by said client, and calculating the utilization rate of said one content from said measurement result acquired by sending the result to said retrieval site; and
transmitting a retrieval result to said client according to the utilization rate of said content.

6. The retrieval method for Web content according to claim 5,
wherein said calculation step comprises a step of calculating said utilization rate from a size of a browser of said client, a size of said content and a click count by said client.

7. The retrieval method for Web content according to claim 5,
wherein said calculation step further comprises a step of calculating said utilization rate from a moving amount of a scroll bar in a browser of said client, and a size of said browser.

8. The retrieval method for Web content according to claim 5,
wherein said calculation step further comprises a step of calculating said utilization rate from a total number of pages of said content, and the number of pages viewed by said client.

9. An accounting method for content of a Web site connected with a client via a network, comprising the steps of:
accessing said Web site and displaying the content of said Web site with said client;
measuring a status of viewing one content by said client and sending the result to said Web site;
calculating the utilization rate of said one content from said measurement result; and
calculating an amount to be billed from said utilization rate and general charge of said content.

10. The accounting method for Web content according to claim 9,
wherein said calculation step comprises a step of calculating said utilization rate from a size of a browser of said client, a size of said content and a click count by said client.

11. The accounting method for Web content according to claim 9,
wherein said calculation step further comprises a step of calculating said utilization rate from a moving amount of a scroll bar in a browser of said client, and a size of said browser.

12. The accounting method for Web content according to claim 9,
wherein said calculation step further comprises a step of calculating said utilization rate from the total number of pages of said content and the number of pages viewed by said client.

13. A retrieval server for searching content of a Web site connected with a client via a network, comprising:
a file for storing the utilization rate of one content calculated from a measurement result acquired by measuring a status of viewing the one content by said client and sending the result to said retrieval site; and
a server for referring to the utilization rate of said content and sending a retrieval result to said client according to a retrieval request from said client.

14. The retrieval server according to claim 13,
wherein said server calculates said utilization rate from a size of a browser of said client, a size of said content and a click count by said client.

15. The retrieval server according to claim 13,
wherein said server calculates said utilization rate from a moving amount of a scroll bar in a browser of said client, and a size of said browser.

16. The retrieval server according to claim 13,
wherein said server calculates said utilization rate from a total number of pages of said content and the number of pages viewed by said client.

17. A content providing device connected with a client via a network, comprising:
a file for storing the utilization rate of one content calculated from a measurement result acquired by measuring a status of viewing the one content by said client and sending the result to said content providing device; and
a server for calculating an amount to be billed from said utilization rate of said content and general charge of said content.

18. The content providing device according to claim 17,
wherein said server calculates said utilization rate from a size of a browser of said client, a size of said content and a click count by said client.

19. The content providing device according to claim 17,
wherein said server calculates said utilization rate from a moving amount of a scroll bar in a browser of said client and a size of said browser.

20. The content providing device according to claim 17,
wherein said server calculates said utilization rate from a total number of pages of said content and the number of pages viewed by said client.
